(19) United States
(12) Patent Application Publication
(10) Pub. No.: US 2024/0010294 A1
(43) Pub. Date: Jan. 11, 2024

(54) ANTI-VIBRATION HANDLE GRIP

(71) Applicants: Antonina PIRROTTA, Palermo (IT); Andrea EVOLA, Cinisi (PA) (IT)

(72) Inventors: Antonina PIRROTTA, Palermo (IT); Andrea EVOLA, Cinisi (PA) (IT)

(21) Appl. No.: 18/279,318

(22) PCT Filed: Feb. 25, 2022
(86) PCT No.: PCT/IB2022/051673

§ 371 Date: Aug. 29, 2023

(30) Foreign Application Priority Data
Mar. 1, 2021 (IT) 102021000004691

(51) Int. Cl. B62K 21/26

(52) U.S. Cl. CPC B62K 21/26

(57) ABSTRACT

A distinctly anti-vibration handle grip, in particular for motorcycles, allows a significant reduction in the transmitted vibrations, eased by a better adaptation of the handle grip to the anthropometric features of the driver's hand, and comprises: an internal cylinder (4), which is fitted on the receiving stem; and an external casing (5), enclosing said internal cylinder ((44)) from a proximal end (2) to a distal end (3) of the anti-vibration handle grip (1), and which is connected to said internal cylinder (4) by means of a sequence of circumferential junctions (6), forming a corresponding sequence of grooves (7) on the external surface of the external casing (5) and respective inner tubes (8), formed by the empty space between external casing (5) and internal cylinder (4), between each one of said grooves (7), wherein the distances between the adjacent grooves depend upon the anthropometric measurements of the user's hand.

### FIELD OF THE INVENTION

The present invention relates to an anti-vibration handle grip, in particular for use as handle grip of the handlebar of motorcycles, bicycles, scooters, motorbikes and other vehicles equipped with handlebar as steering member, whereon the driver keeps his/her own hands on the handle grips.

### BACKGROUND

Such handle grip is adapted to be mounted on a fixed or rotating receiving stem, and it is arranged to be grasped by one hand, and on this regard the handle grip has a proximal end, adjacent to the thumb, and a distal end, adjacent to the little finger.

However, it is to be meant that the anti-vibration handle grip according to the present invention could also be used in any mechanical apparatus providing for the use of handle grips subjected to vibrations, such as, by way of examples, pneumatic hammers, chainsaws, mowers and so on.

Whoever has ridden a motorcycle for several kilometers will have felt an unpleasant tingling sensation in their hand. Such tingling is induced by the vibrations which are transmitted through the wheels and the engine to the handlebar, and then to the handle grips whereon the driver keeps constantly his/her hands. The tingling, and other unpleasant sensations associated to grasping a vibrating handle grip, can cause different more or less severe pathologies, thereof the most common example is the so-called carpal tunnel syndrome.

The carpal tunnel is a strict and stiff passage consisting, at the wrist skeleton, of the ligament and of the bones at the hand basis. Inside thereof the median nerve and the tendons pass. Sometimes, the enlargement of the tendons or other conditions, like those mentioned above, induce a swelling of inflammatory origin, which in turn restricts the tunnel, by making that the median nerve is compressed, causing unpleasant sensations of pain and weakness or numbness to hand and wrist, which irradiate towards the arm.

However, such sensations not only are unpleasant, but can jeopardize the driving capability of the driver, and then the safety in using a vehicle controlled by handlebar.

By analyzing the vibrations induced on the human wrist while driving a motorcycle, one has thought to implement handle grips capable of attenuating the sensations mentioned previously, and their clinical consequences.

The state of art provides for the use of handle grips made of soft material such as rubber and the like, but this does not limit the transmission of vibrations to an extent sufficient to contrast the above-described phenomenon.

French patent No. FR 933,451 describes an anti-vibration handle grip having a casing, enclosed around a stem, having internally empty spaces which make it deformable. Similar handle grips are described in U.S. Pat. Nos. 2,618,986 A and 599,131 A, in Japanese utility model No. JP S 5,037,249 U and in International patent application No. WO 99/39,970 A1.

### SUMMARY

The technical problem underlying the present invention is to provide an anti-vibration handle grip allowing to obviate the drawback mentioned with reference to the known art.

Such problem is solved by a handle grip as specified above, which characterizes in that it comprises an internal cylinder, which is fitted on the receiving stem; and an external casing, enclosing said internal cylinder from a proximal end to a distal end of the anti-vibration handle grip, and which is connected to said internal cylinder by means of a sequence of circumferential junctions, forming a corresponding sequence of grooves on the external surface of the external casing and respective inner tubes, formed by the empty space between external casing and internal cylinder, between each one of said grooves.

In the anti-vibration handle grip according to the present invention the distances between the adjacent grooves in case depend upon the anthropometric measurements of the user's hand, as defined in the enclosed claims, for a customized production and a better adaptation to a user's hand.

The main advantage of the anti-vibration handle grip according to the present invention consists in a significant reduction in the transmitted vibrations, eased by a better adaptation of the handle grip to the anthropometric features of the driver's hand.

### BRIEF DESCRIPTION OF THE DRAWINGS

The present invention will be hereinafter described according to a preferred embodiment example thereof, provided by way of example and not for limitative purposes with reference to the enclosed drawings wherein:

FIG. 1 shows a human fist, wherein some significant anthropometric measurements are designated;

FIG. 2 shows a front view of an anti-vibration handle grip according to the present invention, with shown section plans A-A and B-B;

FIG. 3 shows a longitudinal section of the anti-vibration handle grip of FIG. 2, according to the section plan B-B;

FIG. 4 shows a cross-section of the anti-vibration handle grip of FIG. 2, according to the section plan A-A; and

FIG. 5 shows a perspective front view of the handle grip of FIG. 2; and

FIG. 6 shows the view of FIG. 5 with an oblique section with respect to the longitudinal axis of the handle grip.

### DETAILED DESCRIPTION OF THE PREFERRED EMBODIMENTS

With reference to the figures, an anti-vibration handle grip is designated as a whole with 1.

The handle grip 1 is intended to be mounted on a receiving stem which, in a specific application example, consists of an end stem of a motorcycle handlebar.

On this regard, the handle grip could be of fixed type, or it could constitute a control member of the vehicle, and then it could be used to rotate said stem to control the accelerator or a brake, or to perform a gear shift.

Generally, the handle grip 1 has a substantially cylindrical shape and it is hollow, indeed to receive the terminal stem of a handlebar, in a forced interlocking relationship, which in turn can be reinforced by means of applying an adhesive, or other fastening systems such as bands or side joints, or a bayonet joint.

In each case, the handle grip has to be clasped in the driver's fist to control the vehicle direction and to assume a stable and safe driving position. Then, it is grasped by one hand, and it has a proximal end, adjacent to the thumb, and a distal end, adjacent to the little finger.

At the proximal end, the handle grip 1 comprises a stiff base disc 2, perforated in the center thereof, the diameter thereof being larger than the diameter of the handle grip 1. By projecting diametrically, it acts as a guard and prevents the hand grasping the handle grip 1 from slipping from the handle grip towards the handlebar center, and it eases the grip, by providing the user a reference about the position that his/her hand has to have to perform a firm grip.

At the distal end, the handle grip 1 has a case back 3 closing the internal cavity.

Therefore, the handle grip 1 has a hollow cylindrical structure longitudinally elongating, adapting to the extension of the receiving stem, and it is opened at said proximal end.

The body of the handle grip 1 comprises an internal cylinder 4, which is fitted with forced interlocking on the receiving stem shaped to adapt and to connect thereto.

Moreover, the handle grip 1 comprises an external casing 5, enclosing said internal cylinder 4 from the proximal end 4 to the distal end 5 of the anti-vibration handle grip 1, which constitutes its external surface in contact with the user's hand.

The external casing 5 is connected to the internal cylinder 4 by means of a series of circumferential junctions 6 forming a respective sequence of grooves 7 on the external surface of the external casing 5 and respective inner tubes 8, formed by the empty space between external casing 5 and internal cylinder 4, between each one of said grooves 7.

Going from the innermost groove 7, that is the one nearest to the proximal end 2 and corresponding to the index finger, to the subsequent groove 7, corresponding to the middle finger, the distance in longitudinal direction is designated with F, whereas the distance between this groove 7 and the subsequent one, corresponding to the ring finger, is designated with E, and the distance between the latter groove 7 and the subsequent and last one, corresponding to the little finger, is designated with C.

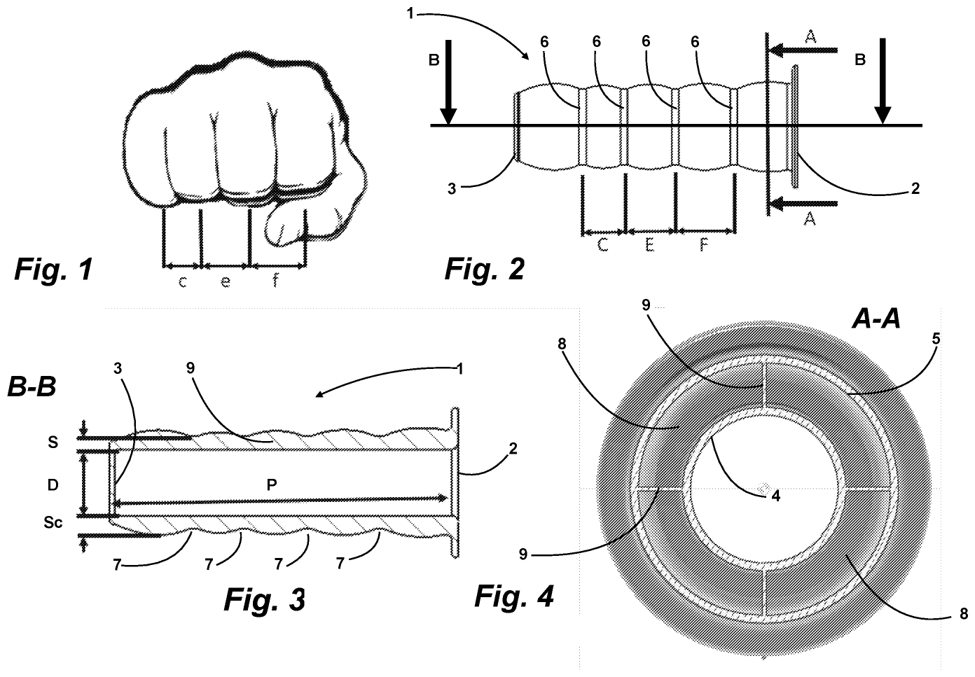

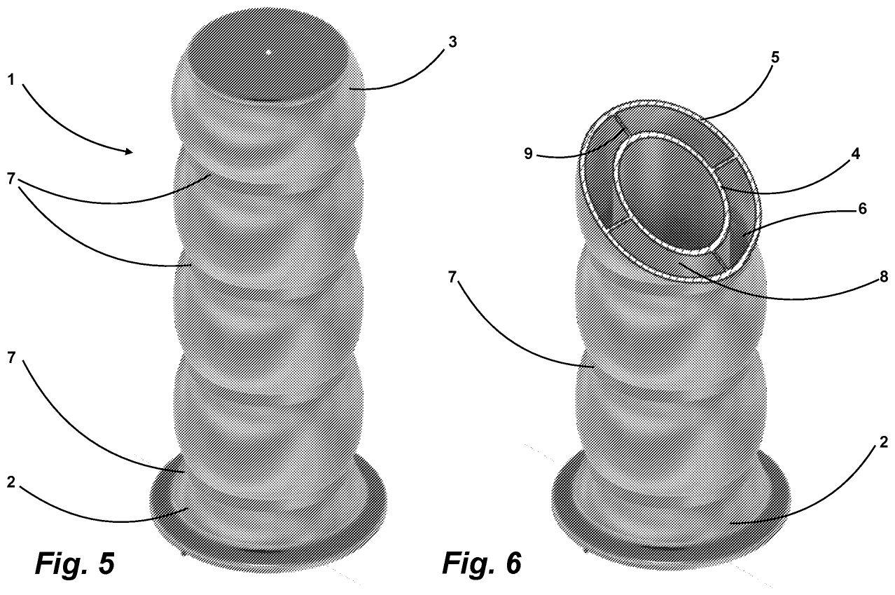

The anti-vibration handle grip 1 is intended to be grasped by a fist (FIG. 1), or by the hand fingers, tight and adjacent therebetween. The distance between the median planes of the single fingers, going from the index finger to the little finger, varies going from one finger to the other one.

The measurements corresponding to the distance between index finger and middle finger, to the distance between middle finger and ring finger and to the distance between ring finger and little finger can be detected by a user's hand, therefor one wishes to produce a customized anti-vibration handle grip, or one wishes to select it from a catalogue of anti-vibration handle grips according to the invention, thus by considering such measurements.

Therefore, once designated such measurements with:
f—distance between index finger and middle finger
e—distance between middle finger and ring finger
c—distance between ring finger and little finger
one could check, by way of example only, the following condition:

f>e>c

However, these anthropometric measurements could vary from subject to subject, and the above-mentioned relation could not be checked, and be replaced by another relation.

Should, by way of example, the relation:

f>e>c
between the anthropometric measurements of the user's hand be valid, then the condition:

F>E>C
has to be checked, considering the presence of four grooves. Should the grooves 7 be only three, the condition F>E should be checked.

A different relation between “f”, “e” and “c” will lead to a corresponding relation between “F”, “E” and in case “C”, so as to meet the anthropometric measurements of the user's hand which have been measured for customization and/or for selection from a catalogue.

Therefore, in this specific case, the distance in longitudinal direction between the groove nearest to the proximal end and the subsequent groove is higher than the distance in longitudinal direction between the latter and the still subsequent groove, and so on.

Conveniently, the handle grip can be implemented in customized way, by adapting the measurements of “F”, “E” and “C” to the measurements of “f”, “e” and “c”.

In particular, the following relation:

F=f+x

E=e+x

C=c+x

will be applied, wherein 1.0 mm<x<3.0 mm—preferably

1.5 mm<x<2.5 mm

By way of example, x=2.0 mm

With reference to FIG. 3, the measurements P (length of the internal cylinder 4) and D (diameter of the internal cylinder 4) depend upon the stem thereto the handle grip 1 is applied.

Moreover, the thickness “S” of the internal cylinder 4 and of the junction 6 is identified which, by way of example, could be higher than 5.0 mm.

The thickness “Sc” of the inner tube 8 will be defined by

Sc=S+y
wherein 1.5 mm<y<3.5 mm
preferably 2.0 mm<y<3.0 mm
and, by way of example, y=2.5 mm

The external casing 5 and the internal cylinder 4 are further connected by longitudinal septa 9, formed by walls extending in a radial direction with respect to the longitudinal axis of the handle grip 1.

In the present embodiment example, such longitudinal septa 9 are four, and are equally spaced therebetween, that is separated by a 90° angle on the periphery of the handle grip 1. It is meant that the number of the septa 9 could vary to meet particular design requirements, having the function of stiffening the structure of the handle grip 1 and of easing the rotation transmission from the external casing 5, thereon the hand acts, to the receiving stem, in particular when it has to be rotated.

In particular, the external casing 5 and said longitudinal septa 9, and in case even the internal cylinder 4, are made of an anti-vibration material.

Then, between each groove 7 receiving a hand's finger four air cushions, inside the handle grip 1, are obtained, dampening pneumatically the stresses transmitted by the handlebar stem.

The above-described anti-vibration handle grip is able to lower, significantly, the stresses transmitted through the handlebar stems, in particular in the frequency range 8-50 Hz.

Moreover, it is possible to implement an ergonomic, in case customized, shape so as to have a greater driving comfort and a consequent lower gripping force on the handle grip.

In each case, it is possible to adapt the handle grip to the geometrical features of the handlebar stem on which the handle grip has to be installed, by obtaining an effective capability of responding rigidly to torsional stresses of the handle grip, so as not to alter the accelerator response during the rotation of the same.

At last, it is to be noted that the handle grip can be produced based upon the stem specifications and even based upon the anthropometric measurements of the user's hand, after their accurate measurements.

Based upon these measurements, it will be possible to select the handle grip with the most suitable measurements from a catalogue, or to produce it in a wholly customized way, for example by means of an additive printing process (3D printing).

Thanks to this additive printing process it is possible to produce the internal cylinder 4, the external casing 5 and the disc 2 in one single piece, and in case of different materials, with different stiffness.

Advantageously, the material of which the base disc consists 2 has a greater stiffness than the material of which the external casing 5 and the longitudinal septa 9 consist.

An example of stiffer material for the base disc 2 is a thermoplastic resin, preferably a polyester such as polyethylene terephthalate, and still more preferably a copolyester of polyethylene terephthalate glycol-modified (PETG), suitable to be used in additive processes.

This material allows to implement an optimum adherence with the metal surface of the tube constituting the stem thereon the handle grip is mounted.

The external casing 5 and the longitudinal septa are made of a more flexible and elastic material, for example a thermoplastic polyurethane (TPU), preferably a TPU-85A.

To the above-described anti-vibration handle grip a person skilled in the art, with the purpose of satisfying additional and contingent needs, could bring several additional modifications and variants, however all comprised within the protective scope of the present invention, as defined by the enclosed claims.

1. An anti-vibration handle grip (1), adapted to be mounted on a receiving stem and arranged to be grasped by a user with one hand, the anti-vibration handle grip (1) having a proximal end, adjacent to a user's thumb, and a distal end, adjacent to a user's little finger, the anti-vibration handle grip (1) comprising:
an internal cylinder (4), which is fitted on the receiving stem; and
an external casing (5), enclosing said internal cylinder (4) from the proximal end to the distal end of the anti-vibration handle grip (1), and which is connected to said internal cylinder (4) by means of a sequence of circumferential junctions (6), forming a corresponding sequence of grooves (7) on an external surface of the external casing (5) and respective inner tubes (8), formed by an empty space between external casing (5) and internal cylinder (4), between each one of said grooves (7),

2. The anti-vibration handle grip (1) according to claim 1, wherein, considering distances (F, E, C) in a longitudinal direction between adjacent grooves (7), and considering the distance measured between the median planes of individual fingers of a user's hand:
f—being the distance between a user's index finger and middle finger
e—being the distance between a user's middle finger and ring finger
c—being the distance between a user's ring finger and little finger
the anti-vibration handle grip (1) is produced in a customized way so that, the above-mentioned longitudinal distances (F, E, C) being:
F=f+x
E=e+x
and C=c+x,
wherein x is comprised in a range between 1.0 mm and 3.0 mm.

3. The anti-vibration handle grip (1) according to claim 2, wherein the internal cylinder (4) and the external casing (5) are implemented in one additive printing process, after detecting measurements of at least one of: a distance between index finger and middle finger (f), a distance between middle finger and ring finger (e) or distance between ring finger and little finger (c) of a user.

4. The anti-vibration handle grip (1) according to claim 3, wherein said additive printing process produces the internal cylinder (4) and the external casing (5) in one single piece.

5. The anti-vibration handle grip (1) according to claim 3, wherein the internal cylinder (4) and the external casing (5) are made of different materials in said additive printing process.

6. The anti-vibration handle grip (1) according to claim 2, wherein the distance (F) in longitudinal direction between the groove (7) nearest to the proximal end (2) and a subsequent groove (7) is greater than the distance (E) in longitudinal direction between the subsequent groove and a further subsequent groove (7).

7. The anti-vibration handle grip (1) according to claim 1, wherein four grooves (7) are present defining three longitudinal distances (F, E, C) between adjacent grooves (7) from the proximal end (2) to the distal end (3).

8. The anti-vibration handle grip (1) according to claim 2 wherein
1.5 mm<x<2.5 mm.

9. The anti-vibration handle grip (1) according to claim 1, wherein a thickness (S) of the internal cylinder (4) and of the junction (6), is greater than 5.0 mm, and wherein the thickness (S_{c}) of the inner tube (8) is defined by
S_{c}=S+y
wherein 1.5 mm<y<3.5 mm.

10. The anti-vibration handle grip (1) according to claim 9, wherein 2.0 mm<y<3.0 mm.

11. The anti-vibration handle grip (1) according to claim 1, wherein the external casing (5) and the internal cylinder (4) are further connected by longitudinal septa (9), formed by walls extending in a radial direction with respect to a longitudinal axis of the anti-vibration handle grip (1).

12. The anti-vibration handle grip (1) according to claim 11, wherein said longitudinal septa (9) are equally spaced therebetween.

13. The anti-vibration handle grip (1) according to claim 1, further comprising, at its proximal end, a stiff base disc (2), perforated in the center, the diameter thereof is larger than the diameter of the handle grip (1) so that the base disc projects diametrically, wherein the material of which the base disc (2) is comprised has a greater stiffness than the material of which the external casing (5) and the longitudinal septa (9) are comprised.
